(19) United States
(12) Patent Application Publication
(10) Pub. No.: US 2009/0136674 A1
(43) Pub. Date: May 28, 2009

(54) Polymer spraying system and method

(76) Inventor: Xiaoyong Yang, Shenzhen (CN)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/069,736

(22) Filed: Feb. 12, 2008

(30) Foreign Application Priority Data
Feb. 12, 2007 (CN) 200710073328.6

(51) Int. Cl. B05D 1/00

(52) U.S. Cl. 427/422; 222/54

(57) ABSTRACT

The rubber sprayer for coating leakage-preventing and noise-reducing rubber layer to inner surface of automobile tire includes a rubber smelting tub divided into a fast smelting area, a heating area and a maintaining area and provided with a heat dissipating plate; an air-rubber cylinder including and air cylinder with an upper hole to the outside and a lower hole to the air pump, and a rubber cylinder connected serially to the air cylinder communicated via a first non-return valve to the rubber smelting tub and communicated via a second non-return valve to a rubber conveying pipe; and a nozzle mechanism. It has also a heating layer controlled with a temperature controller and a maintaining layer in the rubber liquid flow part, and a shifting unit. The present invention features its optimized rubber liquid temperature control, proper viscosity control and continuous operation.

### FIELD OF THE INVENTION

The present invention relates to devices and methods for coating the inner surface of a tire with a polymer or rubber. More particularly, the present invention relates to a rubber sprayer that liquefies solid-state rubber by applying heat, so that the melted rubber can be sprayed on an object surface to form a protective coat. The effectiveness of the rubber coat relies on proper control of the rubber fluid temperature.

### BACKGROUND OF THE INVENTION

Existing rubber sprayer technology includes a melting tub for solid rubber melting, a double cylinder connected to the melting tub's base, an air pump, a transmitting pipe attached to the double cylinder and a spraying nozzle. The double cylinder activates its pistons using the air pump to extract rubber from the melting tub. Fluid rubber is then conveyed to the spraying nozzle to be ejected. Under the existing technology, temperature in the melting tub is uniform throughout as radiating heat is conducted by air within the tub to liquefy solid-state rubber. However, this method of heat conduction leads to the uneven melting of the rubber and creates different densities in different parts of the adhesive polymer, which in turn affects the spraying process. Continuous heating after liquefaction also can result in burning of the rubber. As the liquid rubber is not kept warm after the initial heating, there could a large variance in its temperature. As a result of these restrictions in the dissolving and melting processes, existing rubber sprayers cannot operate continuously.

Under existing technology, the extracting air cylinder and the rubber storage cylinder form the double cylinder and share the same tank body, which results in a low efficiency rubber fluid extraction. Therefore the existing sprayers rely on good fluidity for smooth spraying. In order to achieve good fluidity the temperature of the liquefied rubber needs to be quite high, which then often leads to overheating or burning of the rubber and the destruction of its chemical structure. The result of this overheating or burning is often significantly reduced or non-existent leak protection by the rubber coating on the vehicle tire. Due to these problems, current rubber sprayers cannot produce consistent, high quality coverage of the surface.

Under existing technology, rubber is not heated evenly in the melting tub, thus different parts of the fluid rubber have different adhesive densities. Since the fluid rubber is not mixed in any way to create uniform density and temperature before being sprayed, the sprayed coat made of this uneven mixture of rubber also takes an uneven form and produces imperfect results. The density differences also affect the rubber fluidity. In existing rubber sprayers, because the connecting pipes/tunnels are not heated or kept warm, the fluid rubber loses heat while circulating through these pipes/tunnels. Consequently, it is much harder for the fluid rubber to remain at a relatively constant temperature and it is very difficult to attain the best spraying temperature.

### SUMMARY OF THE INVENTION

This invention is created to solve the technical difficulties of achieving good rubber spraying results in existing rubber sprayers, and proposes a new machine with better rubber spraying performance.

The present invention is a type of industrial rubber sprayer used to apply adhesive polymer on the inner surface of a vehicle tire to reduce travel noise and prevent air leakage. The spraying system consists of a melting tub, a double cylinder, a transmitting pipe, and a spraying nozzle. The heat radiating melting tub is divided into three compartments from top to bottom: rapid melting, heating, and warming. There are cooling fins set inside the tub. A serially connected air cylinder and rubber cylinder creates the double cylinder. The primary air cylinder has an upper hole for external linkage and a lower hole to be attached to an air pump; the secondary rubber cylinder uses a one-way valve at its base to link to the melting tub, along with another one-way valve to connect to the transmitting pipe. In addition, a heating and warming unit is included to keep the rubber as a fluid inside of the parts of the sprayer that circulate the rubber. The heating is controlled by a thermostat device. The sprayer component of the machine is mobile if installed on level surface.

The machine distributes the heat evenly inside the melting tub via radiating panels set inside the tub. At the same time, the thermal differences in the three compartments of the tub allow for the maintenance of the best rubber temperature. Having the air cylinder and the rubber cylinder serially connected yet separated creates pressure within the rubber cylinder. Moreover, the three-way valve joining the transmitting pipe with the melting tub enables the backflow of the rubber, which enhances the rubber temperature and adhesiveness. Finally, this enables the system to operate continuously.

One embodiment of the present invention is a rubber sprayer including a melting tub (3), a double cylinder (4) joint to the base of the melting tub (3), a transmitting pipe (5) connected to the double cylinder (4), and a spraying mechanism connected at one end of the transmitting pipe (5). The melting tub (3) is divided into three compartments from top to bottom: rapid melting (24), heating (25), and warming (26). Cooling fins (28) are evenly distributed inside the melting tub (3). Each of the three compartments of the melting tub (3) is wrapped in a heating stratum (15, 015, and 016); then the three components together are again wrapped in a warming stratum (16). The double cylinder (4) contains a primary air cylinder (6) and a secondary rubber cylinder (7) which is covered with heating (15) and warming (16) stratums. The two cylinders are serially joined. A shaft (10) holds two fitted pistons (8, 9) in place inside each of the two cylinders. The air cylinder (6) has an upper hole (11) for external linkage and a lower hole (12) for the attachment to an air pump. The rubber cylinder (7) uses a one-way valve (13) at its base to connect to the base of the melting tub (3), along with another one-way valve (14) to connect to the transmitting pipe (5). The transmitting pipe (5), the spraying mechanism and the pipelines linking the melting tub (3) with the double cylinder (4) are all enclosed by heating (15) and warming (16) stratums on the outside. The heating stratum (15) incorporates a temperature controlling device. Furthermore, the sprayer is equipped with rollers and guides (17) that enable it to be repositioned during operation if installed on a level surface.

The melting tub (3) and the double cylinder (4) are both set on the same platform (18). Tunnels that connect various parts of the sprayer are embedded inside this platform. The first tunnel (19) connects the melting tub (3) with the rubber cylinder (7), while the second (20) unites the rubber cylinder (7) and the transmitting pipe (5). Each tunnel is equipped with a one-way valve; the first (13) and the second (14) one-way valve lie on the first (19) and the second (20) tunnel respectively. Heating (15) and warming (16) stratums are placed at the base of the platform (18).

The first one-way valve (13) is located at the entrance to the rubber cylinder (7) on the first tunnel (19). This valve (13) is shaped like a funnel (21). A ball shape stopper (22) sits inside this funnel (21). The second one-way valve (14) is located at the entrance to the rubber cylinder (7) on the second tunnel (20). It (14) is again shaped like a funnel (23). A ball shaped stopper (22) also sits inside this funnel (23).

The spraying mechanism is assembled by connecting the transmitting pipe (5) to a horizontal spraying tube (30), and then to a vertical spraying tube (29) which is then hooked to a spraying nozzle (31). The tip of the spraying nozzle (31) is shaped like a knob with six evenly distributed blowholes (32). There is a nozzle cap (33) on top of the spraying nozzle (31) covering the central four of the six blowholes (32).

One end of the transmitting pipe (5) is connected to the horizontal spraying tube (30) and the warming compartment (26) of the melting tub (3) by a three-way valve (34).

The three-way valve (34) which connects the transmitting pipe (5), the horizontal spraying tube (30), and the melting tub (3) includes a valve seat (40). This valve seat (40) contains a rotating valve plug (41).

The devices (17) that enable the mobility of the whole unit on a level surface are made of horizontal and vertical slide ways and rollers.

The temperature controlling device has a thermal electro-detector. This electro-detector is connected to a thermostat which is linked to an industrial solid-state relay. The solid-state relay is attached to the heating stratum (15).

There is a measuring bar (37) is installed on the top of the large piston (8) that is located in the air cylinder (6).

The invention is a type of rubber sprayer. Specifically, it is a type of industrial rubber sprayer used to apply adhesive polymer on the inner surface of a vehicle tire to reduce travel noise and prevent air leakage.

### BRIEF DESCRIPTION OF THE DRAWINGS

FIG. 1 is a cut-away side view of an embodiment of the polymer spraying system of the present invention.

FIG. 2 is a top-down view of a bottom plate of an embodiment of the polymer spraying system of the present invention.

FIGS. 3 and 4 are cut-away, side views of a bottom plate of an embodiment of the polymer spraying system of the present invention cut along axes A and B shown in FIG. 2, respectively.

FIG. 5 is top down view of 2 one-way valves positioned at the bottom of a double cylinder of an embodiment of the polymer spraying system of the present invention.

FIG. 6 is cut-away, side view of 2 one-way valves positioned at the bottom of a double cylinder of an embodiment of the polymer spraying system of the present invention cut along axis A shown in FIG. 5.

FIGS. 7 and 8 show a double cylinder of an embodiment of the polymer spraying system of the present invention.

FIGS. 9 and 10 show a cooling fin of an embodiment of the polymer spraying system of the present invention.

FIGS. 11-13 show a three-way valve of an embodiment of the polymer spraying system of the present invention.

FIGS. 14 and 15 show a valve seat and a rotating valve plug of an embodiment of the polymer spraying system of the present invention, respectively.

FIGS. 16 and 17 show a vertical spraying tube and a spraying nozzle of an embodiment of the polymer spraying system of the present invention.

FIGS. 18 and 19 show a spraying nozzle of an embodiment of the polymer spraying system of the present invention.

FIG. 20 shows a chuck with four jaws of an embodiment of the polymer spraying system of the present invention.

FIG. 21 shows a schematic of a temperature controlling device of an embodiment of the polymer spraying system of the present invention.

### DETAILED DESCRIPTION

The present invention solves the technical difficulties of achieving good rubber spraying results in existing rubber sprayers, and proposes a new machine with better rubber spraying performance.

To solve the technical difficulties of the existing technology, the present invention proposes a novel rubber sprayer, which consists of a melting tub, a double cylinder joint to the base of the melting tub, a transmitting pipe connected to the double cylinder, and a spraying mechanism built at one end of the transmitting pipe. The melting tub is divided into three compartments from top to bottom: rapid melting, heating, and warming. Cooling fins are evenly distributed inside the melting tub. Each of the three compartments of the melting tub is wrapped in a heating stratum; then the three components together are again wrapped in a warming stratum. The double cylinder contains a primary air cylinder and a secondary rubber cylinder which is covered with heating and warming stratums. The two cylinders are serially joined. A shaft holds two fitted pistons in place inside each of the two cylinders. The air cylinder has an upper hole for external linkage and a lower hole for the attachment to an air pump. The rubber cylinder uses a one-way valve at its base to connect to the base of the melting tub, along with another one-way valve to connect to the transmitting pipe. The transmitting pipe, the spraying mechanism and the pipelines linking the melting tub with the double cylinder are all protected with heating and warming stratums. The heating stratum incorporates a temperature controlling device. Furthermore, the sprayer is installed with devices to enable mobility on level surface.

The melting tub and the double cylinder mentioned are both set on the same platform. Tunnels are embedded inside this platform, linking various parts of the sprayer. The first tunnel connects the melting tub with the rubber cylinder, while the second unites the rubber cylinder and the transmitting pipe. Every tunnel is equipped with a one-way valve; the first and the second one-way valve lies on the first and the second tunnel respectively. Heating and warming stratums are placed at the base of the platform.

The first one-way valve mentioned is located at the entrance of the rubber cylinder on the first tunnel. This valve is shaped like a funnel. A ball shaped stopper sits inside this funnel. The second one-way valve is located at the entrance of the rubber cylinder on the second tunnel. It is also shaped like a funnel. A ball shaped stopper also sits inside this funnel.

The spraying mechanism mentioned is assembled by connecting the transmitting pipe to a horizontal spraying tube, and then to a vertical spraying tube which is then hooked to a spraying nozzle. The tip of the spraying nozzle is shaped like a knob with six evenly distributed blowholes. There is a nozzle cap on top of the spraying nozzle covering the central four of the six blowholes.

One end of the transmitting pipe is connected to the horizontal spraying tube and the warming compartment of the melting tub by a three-way valve.

This three-way valve connects the transmitting pipe, the horizontal spraying tube, and the melting tub and it includes a valve seat. This valve seat contains a rotating valve plug.

The warming stratum is made of aluminum silicate fiber. The melting tub and the rubber cylinder are both made of steel. The large and the small pistons both have fluorine rubber piston rims mounted on them.

The temperature controlling device includes a thermal electro-detector. This electro-detector is connected to a thermostat which is linked to an industrial solid-state relay. The solid-state relay is attached to the heating stratum.

There is a measuring bar installed on the top of the mentioned large piston located in the air cylinder.

Unlike the existing technology, this invention conducts the heat evenly through radiating panels set inside the melting tub. This design does not rely on air conducted radiating heat inside the melting tub, which leads to uneven heating of rubber. The melting tub is divided into three compartments. Each compartment is warmed to a different temperature that is necessary to achieve the different states of the rubber, using the heating panels outside of the melting tub. This achieves optimal thermal control of the rubber fluid. Having the air cylinder and the rubber cylinder serially connected yet separated creates the necessary pressure, thus highly adhesive rubber can be ejected. Also, the temperature of the fluid rubber can be regulated by the temperature controlling device, which travels through the following units: the melting tub, the double cylinder, the transmitting pipe, the platform and the spraying mechanism. The temperature control device helps to sustain a relatively constant temperature of the fluid rubber by heating and warming, which assures its quality. The three-way valve joining the transmitting pipe with the melting tub enables the backflow of fluid rubber. This back flowing process assures that rubber fluid is mixed thoroughly, so it has an even density and temperature. To sum up, this invention has solved the temperature control problem of the fluid rubber, and because of the melting of the rubber happens in a divided tub, the sprayer is able to operate continuously.

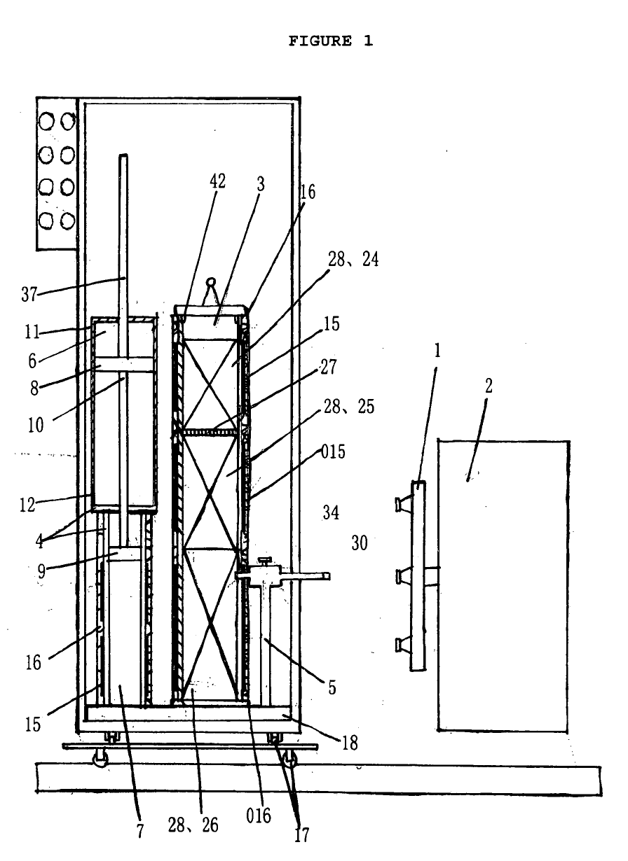

FIG. 1 illustrates the basic operation of the invention, the rubber sprayer. It consists of a melting tub (3), a double cylinder (4), a transmitting pipe (5), and a spraying mechanism. The double cylinder (4) contains a primary air cylinder (6) and a secondary rubber cylinder (7) which is covered with heating (15) and warming (16) stratums. The two cylinders are serially joined. The rubber cylinder (7) uses a one-way valve (13) at its base to connect to the base of the melting tub (3), along with another one-way valve (14) to connect to the transmitting pipe (5). The transmitting pipe (5) is attached to the spraying mechanism. The melting tub (3), the double cylinder's (4) pipelines, the transmitting pipe (5), and the spraying mechanism are all enclosed by heating (15) and warming (16) stratums from the outside. In order to allow for easy operation, this sprayer is installed with devices (17) to enable mobility on level surface.

In this new design there is a large (8) and a small (9) piston fitted inside the air cylinder (6) and the rubber cylinder (7). The large (8) and the small pistons (9) both have fluorine rubber piston rims (36) mounted on them (Refer to FIG. 7, 8). A shaft (10) holds two fitted pistons (8), (9) in place inside each of the two cylinders. The air cylinder (6) has an upper hole (11) for external linkage and a lower hole (12) to enable attachment to an air pump (Not illustrated). To increase air pump efficiency, the diameter of the secondary rubber cylinder (7) is smaller than of the primary air cylinder (6).

As illustrated in FIG. 1, the melting tub (3) is a round cylinder. At the top of the melting tub (3), there is a feeding window with a lid (42). The melting tub (3) is divided into three compartments from top to bottom: rapid melting (24), heating (25), and warming (26). The volume ratio of the three compartments is 2:3:4 respectively. Each of the three compartments of the melting tub (3) is wrapped in a heating stratum (15), (015), and (016). The heating stratums of the melting tub (3) possess higher heating power. The whole body around the melting tub (3) is again wrapped in a warming stratum (16) to avoid heat loss. Meanwhile, cooling fins (8) are also evenly distributed inside the melting tub (3) (Refer to FIG. 9, 10). These cooling fins (28) absorb the heat from the tub's wall while conducting it evenly back to the melting tub (3). These fins (28) are made of crossing arrays of horizontal and vertical metal panels. The rapid melting (24) and heating (25) compartments are separated by a metal sieve (27) with drilled openings. This metal sieve (27) only lets rubber to travel down to the heating (25) and warming (26) compartments in liquid form. In this design, to increase the melting efficiency, the melting tub (3) and the rubber cylinder (7) are made of high heat capacity metal, such as steel. The warming stratum (16) is made of aluminum silicate fiber. Because the melting takes place in a divided tub, the sprayer is able to operate continuously.

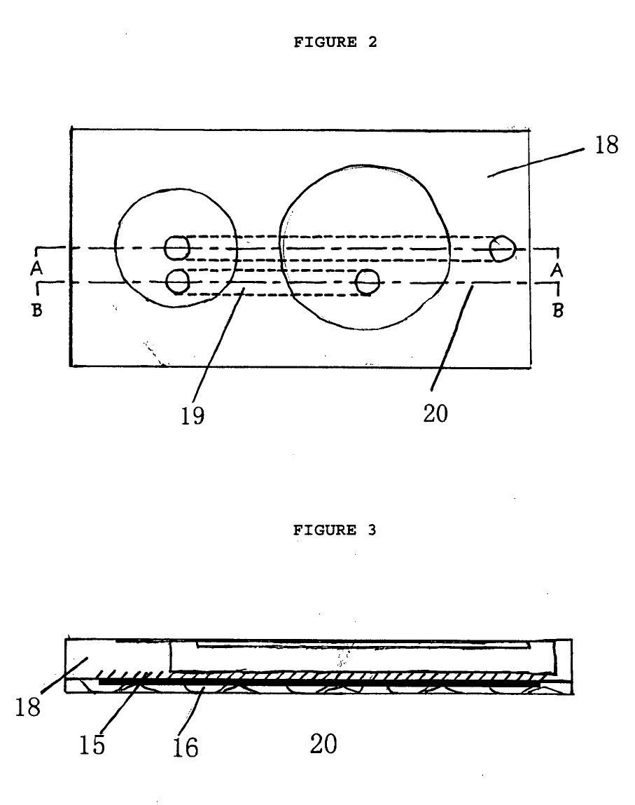

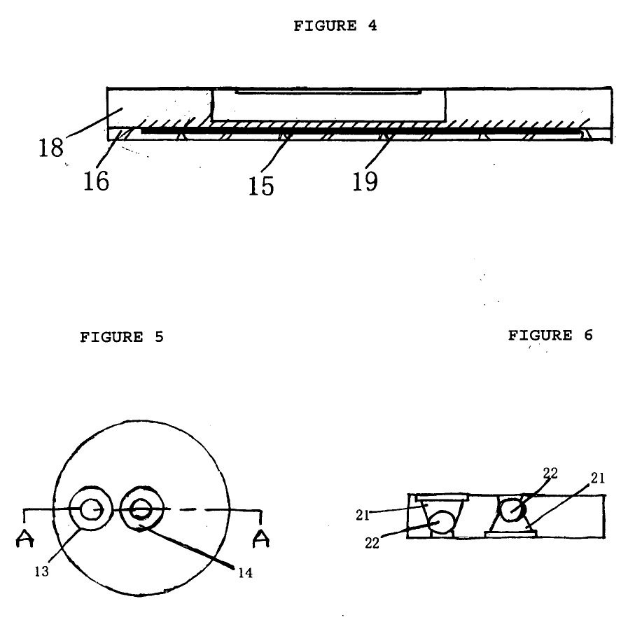

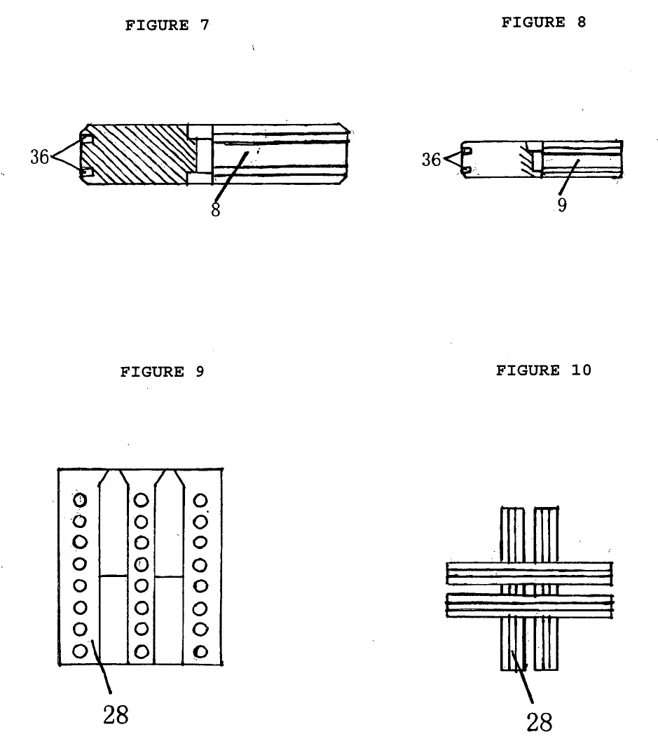

As illustrated in FIG. 1, the melting tub (3) and the double cylinder (4) are mounted on the same bottom plate (18) by flange connections. This plate contains a tunnel (19) that connects the melting tub (3) with the rubber cylinder (7), as well as a second tunnel (20) which unites the rubber cylinder (7) and the transmitting pipe (5). Both tunnels include a one-way valve (Refer to FIG. 2, 3, 4). In this design, the bottom plate (18) is a rectangular metal plate. The two tunnels (19), (20) are produced by multi-directional drilling. Because of the large surface area of the bottom plate (18), when fluid rubber flows through this plate (18), the liquid's temperature drops relatively fast. To retain the temperature heating (15) and warming (16) stratums are installed at the base of the bottom plate (18). The first one-way valve (13) is located at the entrance of the rubber cylinder (7) on the first tunnel (19). This valve (13) is shaped like a funnel (21). A ball shaped stopper (22) sits inside this funnel (21). The second one-way valve (14) is located at the entrance of the rubber cylinder (7) on the second tunnel (20). This valve (14) is also shaped like a funnel (23) and has a ball shaped stopper (22) inside the funnel (23) (Refer to FIG. 5, 6). The use of the two one-way valves (13), (14) only permits the fluid rubber to flow in one direction inside the tunnels.

As illustrated in FIG. 21, the heating stratum used to wrap the parts mentioned above is controlled by a temperature controlling device. This device uses the latest heat and electric energy PLD switching technique. The device includes a thermal electro-detector, a thermostat connected to the detector, and an industrial solid-state relay linked to the thermostat. The solid-state relay is attached to the heating stratum (15). In this design, there are measuring sensors set inside the melting tub's rapid melting (24), heating (25), and warming (26) compartments and the bottom plate (18). Each sensor has a thermal electro-detector in place. The four detectors are separately attached to four thermostats. These four thermostats are plugged into an industrial solid-state relay. Each solid-state relay is connected to the corresponding heating stratum (15). The measuring sensors of the rubber cylinder (7), the transmitting pipe (5), and the spraying mechanism have their thermal electro-detector connected. Because the temperature requirements inside the rubber cylinder (7), the transmitting pipe (5) and the spraying mechanism is similar to that of the melting tub's (3) heating (25) and warming (26) compartments, the thermal electro-detectors on the rubber cylinder (7), the transmitting pipe (5) and the spraying mechanism are parallel connected to the solid-state relay of either the heating (25) or the warming (26) compartment.

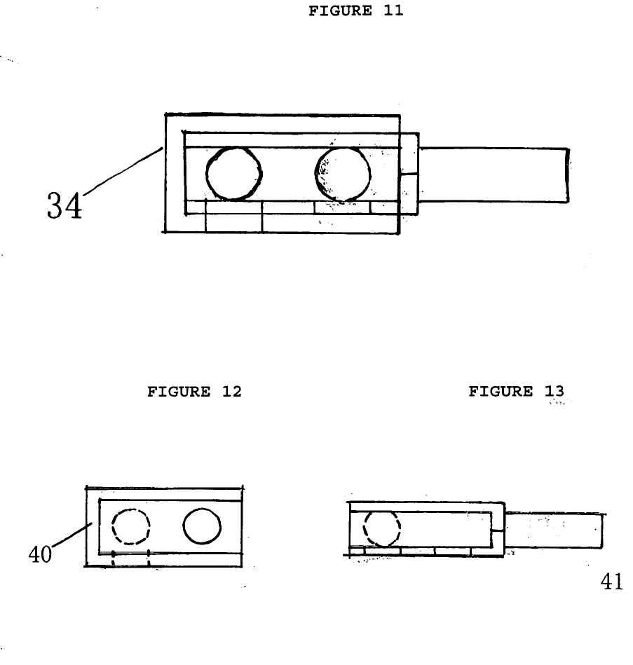

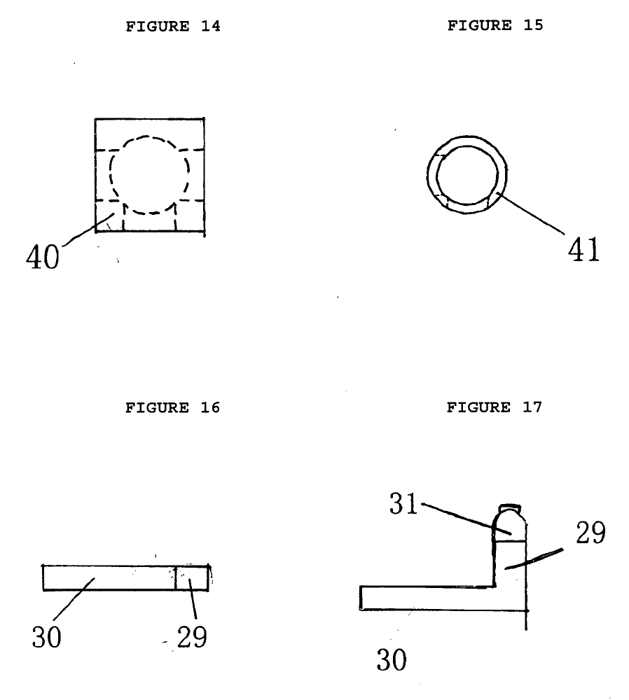

As illustrated in FIG. 1, to gain uniformity in the rubber's temperature and its density at all sprayer components and so create a more uniform rubber layer as an end result, a three-way valve (34) is placed at one end of the transmitting pipe (5). The valve (34) connects the spraying mechanism to the warming compartment (26) of the melting tub (3) and the transmitting pipe (5). The valve (34) also has a valve seat (40) inside with a central cylinder shaped chamber. There are three holes leading to the central chamber on the sidewalls of the valve seat (40). The spraying mechanism, the heating compartment (25) inside the melting tub (3), and the transmitting pipe (5) are joined through these three holes. The cylinder shaped chamber of the valve seat (40) holds a rotating valve plug (41). This plug (41) has three passages on it that matches the three holes on the valve seat (40) (Refer to FIGS. 11, 12, 13, 14, and 15). When the rotating valve plug (41) connects the transmitting pipe (5) with the warming compartment (26) of the melting tub (3), it also blocks the holes of the valve seat (40) that leads to the spraying mechanism. As the rotating valve plug (41) is turned to a certain angle, the passageway between the spraying mechanism and the transmitting pipe (5) opens, and at the same time the holes connecting the warming compartment (26) in the melting tub (3) get blocked. The installation of this three-way valve (34) enables the fluid rubber to flow back to the melting tub (3). This reflowing step permits the rubber to be thoroughly mixed, which evens out the temperature and density differences.

As shown in FIG. 1, the bottom plate (18), the melting tub (3), the double cylinder (4), and the transmitting pipe (5) are all installed inside one container. The devices (17) that enable the mobility of the whole unit on level surface are made of horizontal and vertical slide ways and rollers. These devices are attached to the base of the container.

In order to calculate the amount of rubber fed to the rubber cylinder (7) and the amount sprayed, there is a measuring bar (37) installed on the top of the large piston (8) inside the air cylinder (6). By observing the changes in the readings of the measuring bar (37), together with the rubber cylinder's (7) volume, the amount of rubber extracted can be derived.

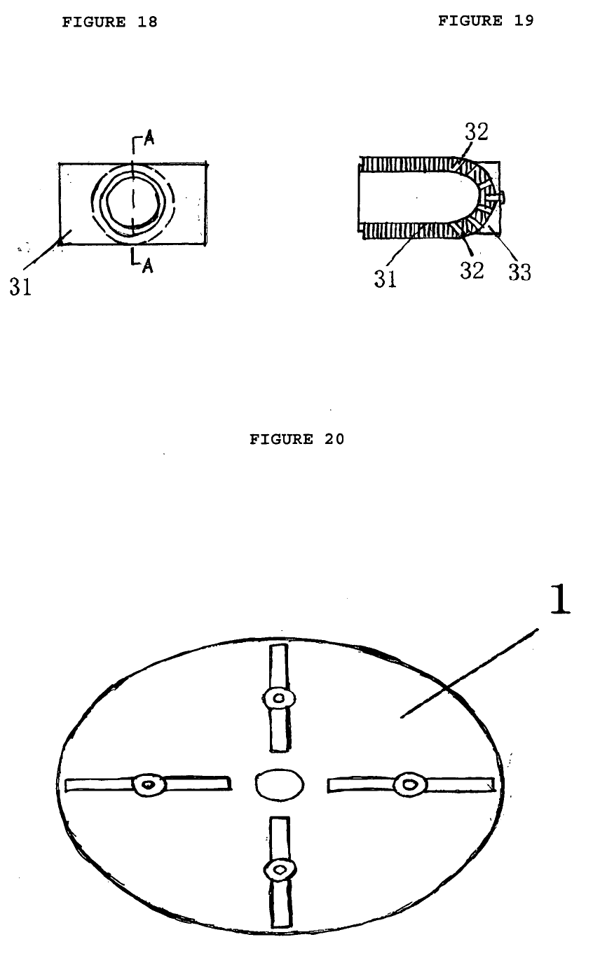

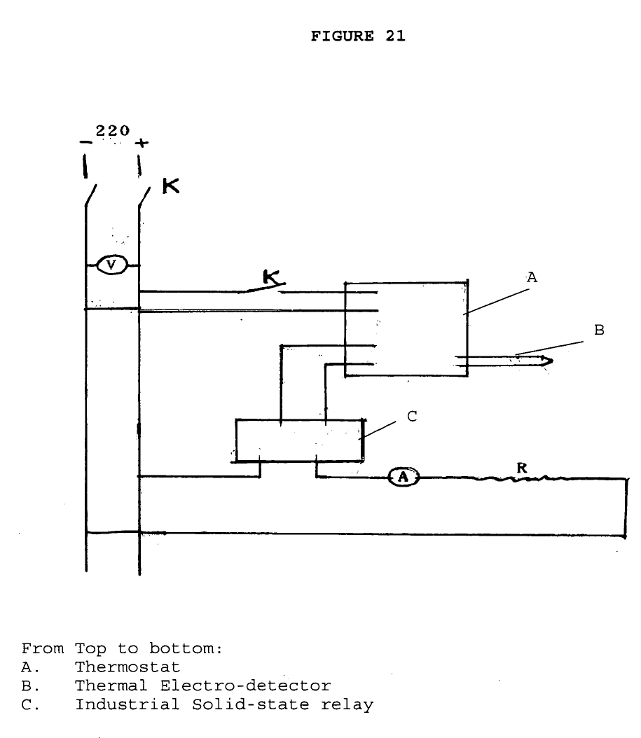

The rubber sprayer described in this instruction manual is designed to accommodate rubber spraying on a vehicle tire, so a chuck with four jaws (1) is used to position the subject tire (Refer to FIG. 20). This chuck (1) spins under the force of a transmission (2), which is a wheel spinning transmission mechanism driven by a unidirectional motor. A gearbox controls the unidirectional motor. While the chuck (1) is spinning the tire, fluid rubber is sprayed on the tire's inner surface evenly to form a rubber coat. To optimize the rubber spraying on said tire, in this design, the spraying mechanism uses the three-way valve (34) to connect the transmitting pipe (5) to the horizontal spraying tube (30), and then to the vertical spraying tube (29) which in turn is connected to the spraying nozzle (31) (Refer to FIG. 16, 17). While the horizontal spraying tube (30) points at the chuck (1), the vertical spraying tube (29) is parallel to the ground and the chuck's (1) radial plane. The tip of the spraying nozzle (31), which sits on top of the vertical spraying tube (29), has a spherical surface with six blowholes (32) evenly distributed around the tip's periphery. The positions of the six blowholes (32) are corresponding to the inner surface of the tire, thus the streams of fluid rubber flowing out of the blowholes (32) form a fan shape. With the aim of forming a rubber coat with equal thickness throughout the tire, there is a nozzle cap (33) on top of the spraying nozzle (31) covering the central four of the six blowholes (32). This nozzle cap (33) is retractable and fitted onto the spraying nozzle (31) by a screw (Refer to FIG. 18, 19).

In this design, given the type of rubber selected, the fluid rubber must be kept at a temperature of 180° C. after liquefaction and the air cylinder (6) needs to have a pressure of 0.4-0.6 Megabar so that the extraction and compression of the fluid rubber can be done smoothly. Before spraying the fluid rubber onto the tire, the tire is clamped onto the chuck (1), and by adjusting the sprayer's position using its moving devices (17), the spraying nozzle (31) can be located relatively close to the inner surface of a tire. Solid-state rubber is inserted into the melting tub (3); the rubber quickly melts inside the rapid melting compartment (24), flows to the heating (25) then to the warming (26) compartments, and deposits in the warming compartment (26) where the temperature of the fluid rubber is maintained at 180° C. Activating the air pump extracts the fluid rubber from the melting tub (3) to the rubber cylinder (7) through the first tunnel (19). At the same time, the valve plug (41) is adjusted so that the transmitting pipe (5) is connected to the warming compartment (26) of the melting tub (3). The fluid rubber is extracted from the rubber cylinder (7), and then reflows back to the melting tub (3) with the use of air pump and through the second tunnel (20) and the transmitting pipe (5). This reflow process can be repeated a number of times to allow for thorough mixing of the fluid rubber. After this mixing of the fluid rubber, the valve (41) is adjusted to connect the transmitting pipe (5) with the spraying mechanism. Fluid rubber is extracted out of the rubber cylinder (7) by the adjusted air pump. This forces the fluid rubber through the second tunnel (20), the transmitting pipe (5), the horizontal spraying tube (30), the vertical spraying tube (29), then to the blowholes (32) of the spraying nozzle (31) to be ejected onto the inner surface of a tire. The centrifugal force generated from the spinning of the tire on the chuck (1) would spread the rubber coat too thin on the two side walls of the inner surface of the tire. To avoid this problem when the sprayer is used on a tire for the first time, the central four blowholes (32) on the spraying nozzle (31) are covered using the nozzle cap (33) and the machine will only start spraying on the two side walls of the inner surface of the tire. When that process is completed, the nozzle cap (33) has to be removed off the spraying nozzle (31), to begin the complete spraying of the inner surface of the tire with all six blowholes (32). This produces an even coat of rubber on the tire. When the fluid rubber travels around the sprayer, if the rubber temperature gets too high or too low at any part of the sprayer, the heating stratum (15) in the sprayer will stop or start heating the fluid rubber under the control of the temperature controlling device, to keep the temperature constant at around 180° C.

In comparison to existing techniques, this new invention conducts the heat evenly through radiating panels set inside the melting tub. This design does not rely on air conducted radiating heat inside the melting tub, which leads to uneven heating of the rubber. The melting tub is divided into three compartments. Each compartment uses a different temperature corresponding to the different states of the liquid rubber, using the heating panels outside of the melting tub. This design enables the best thermal control of the rubber fluid. Having the air cylinder and the rubber cylinder serially connected yet separated creates the necessary pressure so highly adhesive rubber can be ejected. In the meantime, the temperature of the fluid rubber can be managed by the temperature controlling device, while it travels through the melting tub, the double cylinder, the transmitting pipe, the bottom plate and the spraying mechanism. The temperature control device helps to maintain a relatively constant temperature of the fluid rubber which in turn assures its quality. The three-way valve connecting the transmitting pipe with the melting tub enables the back flow of fluid rubber. This back flow process ensures the thorough mixing of the rubber fluid, producing an even density and temperature.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A continuous polymer spraying system comprising:
a heat-radiating melting tub having a top opening, a side wall and a bottom defining a volume, wherein the tub comprises three compartments, from top to bottom, a rapid melting compartment, a heating compartment, and a warming compartment, each compartment comprising a separate heating means;
a sieve means disposed between and separating the rapid melting compartment and the heating compartment, wherein the sieve means permits a fluid to flow from the rapid melting compartment into the heating compartment while confining substantially all solids to the rapid melting compartment;
a spraying means for spraying the fluid;
a pumping means in fluid communication with and between the volume of the tub and the means for spraying a fluid, wherein operation of the pumping means pumps the fluid from the volume of the tub to the means for spraying;
a temperature controlling means for monitoring the temperature of each of the compartments of the tub and adjusting the heat provided to each compartment by the respective heating means to produce and maintain a fluid at a desired temperature.

2. The continuous polymer spraying system of claim 1, further comprising a first transmitting means fluidly connecting the volume of the tub to the pumping means and a second transmitting means fluidly connecting the pumping means to the spraying means, wherein each transmitting means comprises a separate heating means controlled the temperature controlling means.

3. The continuous polymer spraying system of claim 1, wherein the pumping means is a double cylinder.

4. A method of applying a polymer to an inner surface of a tire comprising:
a) providing a polymer sprayer comprising:
i) a melting tub for melting and containing a polymer wherein the tub comprises three compartments, from top to bottom, a rapid melting compartment, a heating compartment, and a warming compartment,
ii) an independent heating means for each compartment of the melting tub adapted to melt a solid polymer and maintain a fluid polymer at a desired temperature, and
iii) a spraying means for spraying the fluid polymer onto an inner surface of a tire;
b) introducing a solid polymer into the rapid melting compartment tub;
c) melting the solid polymer to produce a fluid polymer;
d) independently adjusting the heating means for each compartment of the melting tub to maintain the polymer in a fluid state at a desired temperature throughout the polymer sprayer; and
e) spraying the fluid polymer onto the inner surface of the tire.
